(19) United States
(12) Patent Application Publication
(10) Pub. No.: US 2026/0264714 A1
(43) Pub. Date: Sep. 10, 2026

(54) SYSTEMS AND METHODS FOR DETECTING AND REPORTING ELEVATED ROAD SURFACE FEATURES

(71) Applicant: Torc Robotics, Inc., Blacksburg, VA (US)

(72) Inventors: Maximilian Koeper, Ostfildern (DE); Maximilian Yassine Beyen, Leutenbach (DE); David Unger, Stuttgart (DE); Jonas Torzewski, Stuttgart (DE)

(21) Appl. No.: 19/074,017

(22) Filed: Mar. 7, 2025

(51) Int. Cl. B60W 60/00; G01S 17/89; G01S 17/931; G06V 20/58

(52) U.S. Cl. CPC B60W 60/001; G01S 17/89; G01S 17/931; G06V 20/582; B60W 2552/20

(57) ABSTRACT

An autonomy computing system of an autonomous vehicle for detecting elevated road surface features, including: receiving driving environment data associated with a current driving environment of the autonomous vehicle based upon analysis of sensor data; analyzing the driving environment data to determine that an elevated road surface feature is present within the driving environment and determine a plurality of properties of the elevated road surface feature; compare the plurality of properties of the elevated road surface feature to vehicle data to generate a plurality of comparison parameters; based upon an analysis of the plurality of comparison parameters, determine a level of risk associated with whether to permit the autonomous vehicle to be operated to drive across the one or more elevated road surface features; and control the autonomous vehicle to operate in accordance with the determined level of risk.

### TECHNICAL FIELD

The field of the disclosure relates to autonomous vehicles and, in particular, to systems and methods for the detection and reporting of elevated road surface features present in the driving environment of the autonomous vehicle via the autonomous vehicle.

### BACKGROUND

In driving, an autonomous vehicle relies on the identification of various objects in the surrounding environment to determine how the autonomous vehicle is controlled. However, the surrounding environment may include various road surface features such as elevated road surface features that may include elevated crossings including hump crossings, railroad crossings, curbs, or other obstacles, all of which pose a risk for low-clearance vehicles such as certain autonomous vehicles (e.g., an autonomous truck (e.g., tractor) that includes an attached trailer).

It can be difficult to ascertain whether it is safe for the autonomous vehicle to be operated to drive across an elevated road surface feature, and the autonomous vehicle becoming immobilized on such an elevated road surface feature can collide with other vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an autonomy computing system of an autonomous vehicle for detecting elevated road surface features is provided. The autonomy computing system includes at least one processor in communication with at least one memory device. The at least one processor is programmed to receive driving environment data associated with a current driving environment of the autonomous vehicle based upon analysis of sensor data from one or more sensors of the autonomous vehicle. The at least one processor is further programmed to analyze the driving environment data to (i) determine that one or more elevated road surface features are present within an area of the driving environment and (ii) determine a plurality of properties of the one or more elevated road surface features present within the area of the driving environment. The at least one processor is yet further programmed to compare the plurality of properties of the one or more elevated road surface features to vehicle data of the autonomous vehicle to generate a plurality of comparison parameters. The at least one processor is programmed to is yet further programmed to, based upon an analysis of the plurality of comparison parameters, determine a level of risk associated with whether to permit the autonomous vehicle to be operated to drive across the one or more elevated road surface features. The at least one processor is yet further programmed to control the autonomous vehicle to operate in accordance with the determined level of risk.

In another aspect, one or more non-transitory computer-readable storage media for detecting elevated road surface features by an autonomous vehicle including a plurality of instructions stored thereon is provided. The instructions, in response to being executed, cause the autonomous vehicle to receive driving environment data associated with a current driving environment of the autonomous vehicle based upon analysis of sensor data from one or more sensors of the autonomous vehicle. The instructions, in response to being executed, further cause the autonomous vehicle to analyze the driving environment data to (i) determine that one or more elevated road surface features are present within an area of the driving environment and (ii) determine a plurality of properties of the one or more elevated road surface features present within the area of the driving environment. The instructions, in response to being executed, yet further cause the autonomous vehicle to compare the plurality of properties of the one or more elevated road surface features to vehicle data of the autonomous vehicle to generate a plurality of comparison parameters. The instructions, in response to being executed, yet further cause the autonomous vehicle to, based upon an analysis of the plurality of comparison parameters, determine a level of risk associated with whether to permit the autonomous vehicle to be operated to drive across the one or more elevated road surface features. The instructions, in response to being executed, yet further cause the autonomous vehicle to control the autonomous vehicle to operate in accordance with the determined level of risk.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous vehicle;

FIG. 2 is a block diagram of the autonomous vehicle shown in FIG. 1;

FIG. 3 is an example illustration of the autonomous vehicle shown in FIG. 1 including a trailer;

FIG. 4A is an example illustration of an elevated road surface feature;

FIG. 4B is an example illustration of another elevated road surface feature;

FIG. 4C is an example illustration of yet another elevated road surface feature;

FIG. 5 is an example illustration of the autonomous vehicle with trailer shown in FIG. 3 in a hang up scenario;

FIG. 6 is an example illustration of profiling of an elevated road surface feature;

FIG. 7 is an example illustration of profiling of an elevated road surface feature in a driving environment;

FIG. 8 is a flow-chart of method operations performed by an autonomy computing system shown in FIG. 2; and

FIG. 9 is a block diagram showing an example configuration of an autonomy computing device according to one embodiment of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

As described herein, one aspect of the driving environment of the autonomous vehicle may include road surface features that may include elevated road surface features such as hump crossings, railroad crossings, and the like, that have an associated risk of a low-clearance vehicle experiencing a “hang up” while driving over such crossings. Additionally, while elevated road crossings such as hump crossings have an elevation above a ground level reference plane, elevated road surface features may also include objects having an elevation below a ground level reference plane, such as pot holes, divots, low-grade areas, etc.. Put another way, a ground surface may generally be designated as a reference plane with which to refer to various road surface features that may have a height profile above the ground reference plane (e.g., a positive elevated road crossing), or a height profile below the ground reference plane (e.g., a negative elevated road crossing). For example, an autonomous tractor trailer may be at risk of getting “hung up” on either of a positive elevated road surface feature such as a hump crossing or a negative elevated road surface feature such as a divot in the road surface.

As used herein, a “hang up” or being “hung up” is when a low clearance vehicle such as a semi-truck or semi-trailer truck becomes immobilized or stuck on an elevated road surface feature such as a railroad crossing due to the geometric relationship between the underside (e.g., undercarriage) of the vehicle and the profile of the crossing. A “hang up” situation presents a variety of risks and other issues, such as collision or disruption of traffic. Additionally, within a “hang up” scenario, a “high centered” problem may exist where an undercarriage of the vehicle is resting on a high point (e.g., a pivot point), causing all or some of the wheels of the vehicle to lose contact with the ground or otherwise lose traction. Traction loss may be more likely in a “high centered” situation than in a non-“high centered” hang up situation.

Autonomous vehicles employ technologies such as perception, localization, behaviors and planning, modeling, and control. Perception technologies enable an autonomous vehicle to sense and process its environment, to identify and classify objects, or groups of objects, in the environment, for example, pedestrians, vehicles, or features of a road being driven on. Localization technologies determine, based on the sensed environment, for example, where in the world, or on a map, the autonomous vehicle is located. Behaviors and planning technologies process data representing the sensed environment and localization or mapping data to plan maneuvers and routes to reach the planned destination for execution by a controller or a control module. Modeling technologies may be rules-based and may model virtual perimeters around detected objects such as elevated road surface features. The autonomous vehicle may be programmed to not drive across an elevated road surface feature that has been determined to present a “hang up” risk. Controller technologies use control theory to determine how to translate desired behaviors and trajectories into actions undertaken by the vehicle through its dynamic mechanical components. This includes steering, braking, and acceleration.

Perception technologies generally use sensors like a camera, a radio detection and ranging (RADAR) sensor, a light detection and ranging (LiDAR) sensor for detecting the surrounding environment of the autonomous vehicle. One aspect of the surrounding environment of the autonomous vehicle that needs attention is features of a road surface including elevated road surface features, as well as objects present on or around the road surface such as railroad tracks, signs, and the like. However, as described above, it can be a difficult task to judge if it is safe for an autonomous vehicle to cross an elevated road surface feature such as a hump crossing and/or a railroad crossing.

In some embodiments, based on analysis of sensor data of the autonomous vehicle, when an elevated road surface feature is detected and profiled, the autonomous vehicle is not allowed to drive across the elevated road surface features if a determination is made that the profile of the elevated road surface feature is likely to cause a “hang up” to occur.

In some embodiments, based on analysis of sensor data from the one or more image sensors, the one or more LiDAR sensors, and/or the one or more RADAR sensors, and upon identifying the presence of an elevated road surface feature, details of the elevated road surface feature such as time and date, location, whether or not a corresponding warning sign was posted nearby, and other details of the surrounding environment may be saved to a memory device for downstream usage such as mapping of crossings and/or for recording such information in one or more associated databases. For example, a local municipality and/or a private entity such as a trucking company may maintain a railroad crossing database for storage of information relating to railroad crossings in a defined geographical area. By way of a non-limiting example, locations of crossings such as railroad crossings may be mapped with detected positions of the crossings in the geographical area, and such information may be used to increase safe driving during subsequent driving trips. As new crossings are detected and reported by the autonomous vehicle while driving along various travel routes and paths, the new crossings are added to one or more databases. A driving travel route or path may be updated or revised based upon identified crossings, for example to avoid a route or path that includes a crossing that represents a high likelihood of “hang up,” and a different route or path may be taken.

It is a difficult task to ascertain whether a given elevated road surface feature such as a crossing may present a high risk of “hang up” with a vehicle such as a tractor trailer due to variances in the clearance of the autonomous vehicle and/or trailer and/or variances in the profiles of the elevated road surface features. For example, a profile of one railroad crossing may not be uniform with a profile of another railroad crossing even when in close proximity to one another. Thus, each detected elevated road surface feature may need to be analyzed on an individual basis relative to the particular vehicle. Moreover, each vehicle may present additional considerations due to the cargo that the vehicle may be transporting. For example, a “hang up” risk factor analysis may be modified if it is known that the autonomous tractor trailer is transporting hazardous chemicals.

In various embodiments described herein, one or more algorithms use heuristics to determine a profile or other characteristics of an elevated road surface feature or the surrounding environment in real-time to update a travel path of the autonomous vehicle in response to detected elevated road surface features. This may include permitting/not permitting the autonomous vehicle to drive across the elevated road surface feature, and/or changing behaviors of the autonomous vehicle such as (i) re-routing the autonomous vehicle, which may include reversing the autonomous vehicle, (ii) communicating with a remote assistance tool or platform for additional guidance on how to proceed, and/or (iii) adjusting the location and/or operation of onboard sensors.

The remote assistance tool or platform may be a computer program and/or a human dispatcher that may be able to remotely assist in making a determination as to whether or not the autonomous vehicle should be driven across the elevated road surface feature or re-routed. For example, a remote human dispatcher may be able to tap into a data feed of a camera of the autonomous vehicle to view the surrounding environment live. Additionally, or alternatively, the remote assistance tool may include a program such as a computer vision program that may act as a remote computer-based dispatcher and assist with analyzing images from the camera for purposes of evaluating a surrounding environment. The human dispatcher may work in tandem with the computer-based dispatcher. In some cases, the human dispatcher may override a decision made by a program associated with control of the autonomous vehicle. For example, the human dispatcher may make a determination that contradicts a computer-based determination in certain situations, although such an occurrence may be infrequent and reserved only for extreme situations (e.g., extreme safety risks, etc.). The elevated road surface features may be identified using one or more sensors, including but not limited to ultrasonic sensors, IR sensors, image sensors, one or more light detection and ranging (LiDAR) sensors, or one or more radio detection and ranging (RADAR) sensors, etc.

Determining risks associated with driving a low clearance autonomous vehicle across elevated road surfaces has additional challenges, as it is a difficult task to derive a set of rules that cover all situations that may be present during driving as well as changing conditions over time. For example, the road itself and/or material of the road that surrounds a hump crossing may deteriorate over time such that a profile of the crossing itself and/or the area immediately surrounding the crossing changes over time, such as compared to a prior driving session. Put another way, past data relating to any given crossing may not always be able to be relied upon due to potential changing structural conditions. For example, a portion of or near an elevated crossing may collapse, develop a pothole, or suffer some other structural failing. In the case of railroad crossing, for example, the railroad track itself may experience changes, such as expanding/contracting due to temperature across different seasons, and/or may shift over time, thereby changing a profile of the railroad crossing. The systems and methods described herein provide a solution to these challenges by use of sensor data in combination with other contextual data such as map data, historical data such as accident data at a particular crossing, other data such as road sign data, and/or other rules and computing logic that include additional criteria that go beyond solely relying on an outdated, static profile of a given elevated road surface feature that may have been captured at a certain moment in time. Accordingly, the systems and methods described herein provide for dynamic profiling of a given elevated road surface feature at the time of encountering the elevated road surface feature.

Profiling of an elevated road surface feature such as a hump crossing, railroad crossing, etc. may include analyzing a plurality of properties including but not limited to (i) height parameters of the elevated road surface feature and of an area surrounding the elevated road surface feature, (ii) angle parameters of the elevated road surface feature and of the area surrounding the elevated road surface feature, (iii) slope parameters of the elevated road surface features and of the area surrounding the elevated road surface feature, (iv) surface characteristics of the elevated road surface feature and of the area surrounding the elevated road surface feature, and/or (iv) distance parameters associated with a distance between the elevated road surface feature and other objects, including a distance between a designated portion of the autonomous vehicle, a distance to a gate/barrier, a distance to road sign associated with the elevated road surface feature, a light such as a traffic light or other warning light adjacent the elevated road surface features, etc.

Vehicle data may include at least one of: (i) ground clearance parameters of the autonomous vehicle and/or of an attached trailer; (ii) wheelbase parameters of the autonomous vehicle and/or of an attached trailer; (iii) front and/or rear overhang parameters of the autonomous vehicle; (iv) loading condition parameters of the autonomous vehicle and/or of an attached trailer; (v) tire parameters of the autonomous vehicle and/or of an attached trailer; (vi) approach angle parameters of the autonomous vehicle; (vii) departure angle parameters of the autonomous vehicle; (viii) breakover angle parameters of the autonomous vehicle; (ix) hitch location of the autonomous vehicle; (x) width, height, length, and/or weight parameters of the autonomous vehicle and/or of an attached trailer; and/or (xi) suspension system parameters of the autonomous vehicle and/or of an attached trailer.

Comparison parameters may include but are not limited to comparing like categories of parameters of vehicle data and a profile of an elevated road surface feature, such as clearance heights of portions of the autonomous vehicle compared to heights of elevated road surface features, angles relating to a hitch and/or a trailer attached to the autonomous vehicle compared to angles of an elevated road surface feature, etc., as described herein.

Controllable behaviors of the autonomous vehicle may include but are not limited to operating the autonomous vehicle to: (i) drive/not drive across the elevated road surface feature; (ii) select a different route; (iii) store new data corresponding to a plurality of properties of the elevated road surface feature and/or to a plurality of comparison parameters in at least one memory device associated with the autonomous vehicle; (iv) transmit the new data to a remote assistant associated with the autonomous vehicle and/or to an associated electronic database configured to store information relating to known elevated road surface features within a designated geographical area; and/or (v) controlling the sensors of the autonomous vehicle to take additional measurements. For example, a local municipality may keep a database of all known railroad crossings in a certain region. Additionally, or alternatively, private entities, such as the owner/operator/provider of an autonomous vehicle fleet, may keep a database of recorded elevated crossings. In some instances, the various databases or subsets thereof may be for public consumption. In other instances, the various databases or subsets thereof may be for private consumption and/or have proprietary information stored therein.

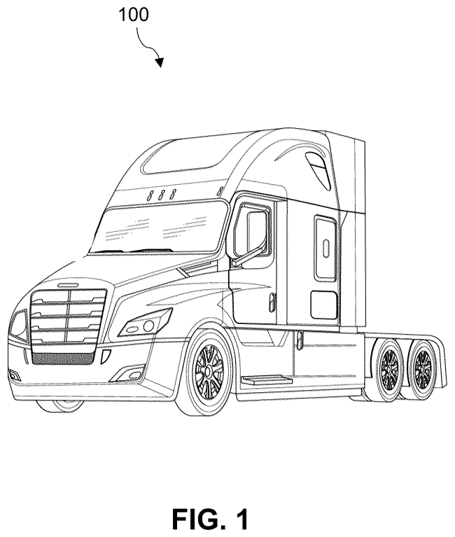

Various embodiments in the present disclosure are described with reference to FIGS. 1-9 below.

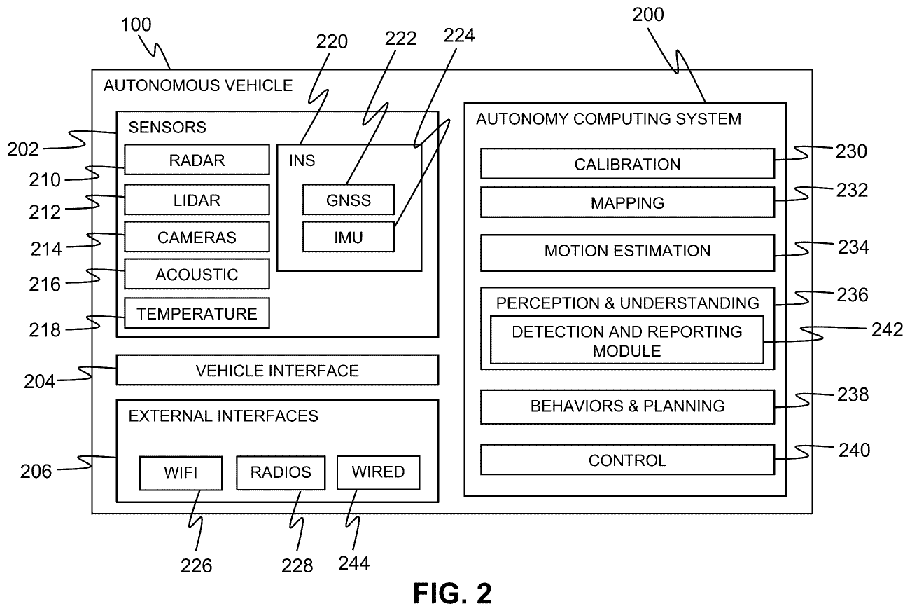

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206, shown in FIG. 2.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, RADAR sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and detection and reporting module 242. Detection and reporting module 242, for example, may be embodied within another module, such as perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

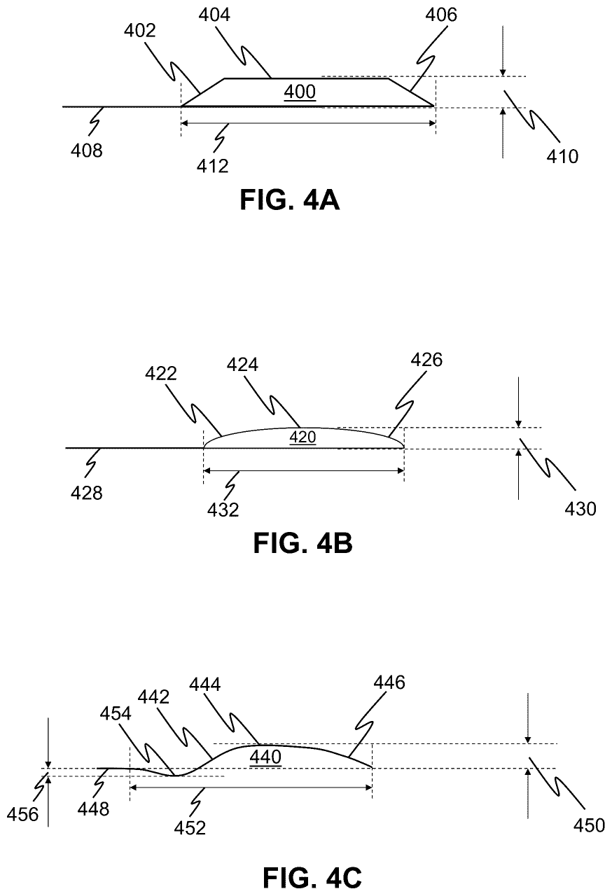

Detection and reporting module 242 may perform one or more tasks including, but not limited to, detecting elevated road surface features such as crossings, determining a profile of a detected elevated road surface feature, updating a travel path of autonomous vehicle 100 based upon the detected and profiled elevated road surface features, and transmitting and reporting data corresponding to the detected elevated road surface features to other modules of the autonomy computing system 200, mission control, or external databases, or each. Tasks performed by detection and reporting module 242 are described in more detail via FIGS. 4-6 (described later), for example.

A plurality of rules may be stored within a memory of autonomy computing system 200 in connection with its various modules such as for detection and reporting module 242. These rules include but are not limited to risk determination rules. Risk determination rules are configured to determine a risk of “hang up” when a vehicle crosses an elevated road surface feature detected by autonomy computing system 200. Risk generation rules are configured to determine risk according to various factors, including but not limited to a profile of the elevated road surface feature that includes height, width, and angle properties of the elevate road surface feature, and vehicle data including but not limited to a known clearance of the vehicle. The profile of the elevated road surface feature may be determined based on sensor data as well as external data such as historical data relating to the elevated road surface feature. As described herein, rules for risk determination may be set and tested based on analysis of real-world log data including sensor data of autonomous vehicles and/or any other types of vehicles.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

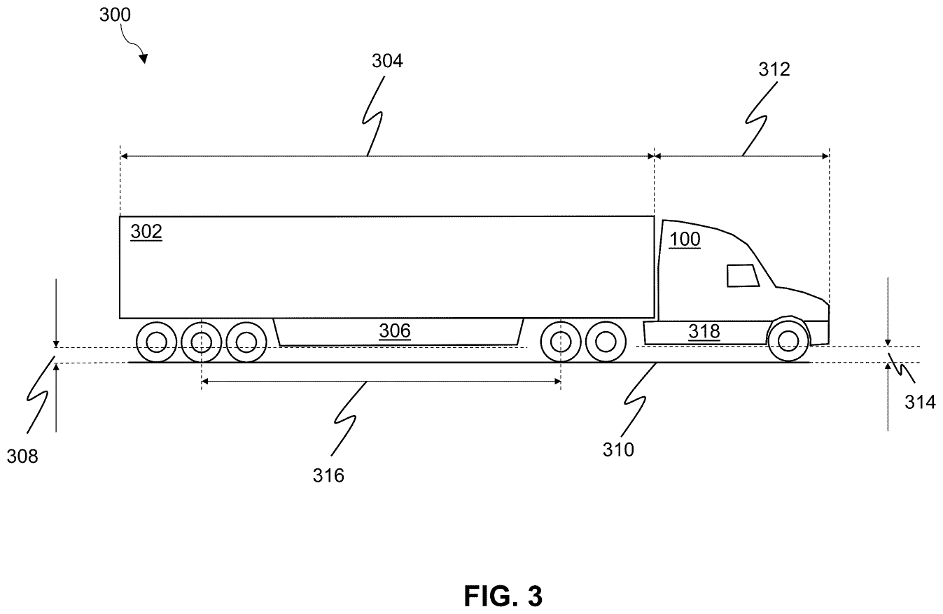

FIG. 3 is an example illustration of autonomous vehicle 100 shown in FIG. 1 in a tractor trailer configuration as a semi-trailer truck 300 including a trailer 302 having a length 304. Trailer 302 may include an undercarriage 306 such that trailer 302 has a certain clearance 308 relative to a surface 310 such as a road surface. Autonomous vehicle 100 (e.g., the tractor) may have a length 312. A total length of semi-trailer truck 300 may be the sum of trailer length 304 and tractor length 312. Autonomous vehicle 100 may have its own clearance 314 relative to surface 310. Additional aspects of trailer 302 may include a wheelbase length 316 which may be measured as a distance between a center point of a front axle (e.g., the axle closest to a tractor connection point such as a hitch) and a center point of a rear axle (e.g., the axle furthest back on trailer 302). Trailer length 304, trailer clearance 308, tractor length 312, tractor clearance 314, and wheelbase length 316 represent some of the main aspects of semi-trailer truck 300 that are considered as part of making a determination of whether it is safe for semi-trailer truck 300 to drive across an elevated road surface feature. Each of trailer length 304, trailer clearance 308, tractor length 312, tractor clearance 314, and wheelbase length 316, as well as additional measurements and/or data relating thereto, may be included as part of vehicle data that is used for comparison with a profile of an elevated road surface feature as described herein. Autonomous vehicle 100 may include its own undercarriage 318. Clearance 308 and clearance 314 may be substantially identical in height to one another in a case where undercarriage 306 of trailer 302 and undercarriage 318 of autonomous vehicle 100 are substantially the same height relative to a ground surface, although some variation may be present between the two.

FIG. 4A is an example illustration of an elevated road surface feature 400 that autonomous vehicle 100 may encounter while driving. More specifically, an elevated road surface feature 400 having a generally trapezoidal form factor including a first angled surface 402, a top surface 404, and a second angled surface 406. First angled surface 402 has a slope between a ground surface 408 and top surface 404 of elevated road surface feature 400, and second angled surface 406 has a slope between ground surface 408 and top surface 404. A profile of elevated road surface feature 400 may include at least a height 410 of top surface 404 relative to ground surface 408, a length/width 412 of elevated road surface feature 400, as well as one or more angles relating to each of first angled surface 402 and second angled surface 406.

FIG. 4B is an example illustration of an elevated road surface feature 420 that autonomous vehicle 100 may encounter while driving. More specifically, an elevated road surface feature 420 having a generally hump-shaped form factor including a first curved surface 422, a peak point 424, and a second curved surface 426. First curved surface 422 has a curvature between a ground surface 428 and peak point 424 of elevated road surface feature 420, and second curved surface 426 has a curvature between ground surface 408 and peak point 424. A profile of elevated road surface feature 420 may include at least a height 430 of peak point 424 relative to ground surface 428, a length/width 432 of elevated road surface feature 420, as well as one or more angles relating to each of first curved surface 422 and second curved surface 426.

FIG. 4C is an example illustration of an elevated road surface feature 440 that autonomous vehicle 100 may encounter while driving. More specifically, an elevated road surface feature 440 having a generally hump-shaped form factor including a first curved surface 442, a peak point 444, and a second curved surface 446. First curved surface 442 has a curvature between a ground surface 448 and peak point 444 of elevated road surface feature 440, and second curved surface 446 has a curvature between ground surface 448 and peak point 444. A profile of elevated road surface feature 440 may include at least a height 450 of peak point 444 relative to ground surface 448, a length/width 452 of elevated road surface feature 440, as well as one or more angles relating to each of first curved surface 442 and second curved surface 446. Compared, for example, to elevated road surface feature 420 in FIG. 4B, elevated road surface feature 440 may further include a negative elevation portion 454 such as a divot in ground surface 448 immediately adjacent elevated road surface feature 440. Negative elevation portion 454 has a height 456 between ground surface 448 and a lowest point of negative elevation portion 454. As shown in FIG. 4C, negative elevation portion 454 is generally below a reference plane (e.g., 0°/180°) of ground surface 448.

The profile of an elevated road surface feature such as elevated road surface features 400, 420, and 440 may be obtained in real-time by sensors 202 of autonomous vehicle 100 once autonomous vehicle 100 is within sufficient range of the elevated road surface feature for sensors 202 to ascertain the geometrical properties of elevated road surface feature 400. Ascertaining length/width properties such as length/width 412, 432, and 452 via sensors 202 may include sensors 202 being configured to ascertain an overall length/width of the elevated road surface feature, as well as a length/width of any sub-portion of the respective elevated road surface features. Similarly, sensors 202 may be configured to ascertain any angles, slopes, and/or other physical characteristics of surfaces of the elevated road surface features, including angled surfaces 402 and 406, curved surfaces 422 and 426, curved surfaces 442 and 446, and/or surfaces of negative elevation portions such as negative elevation portion 454. This may include sensors 202 being configured to ascertain an angle or slope of each respective face of each of these surfaces, or portions thereof. Sensors 202 may further be configured to ascertain an angle between ground surface 408 and surfaces 402 and 406, an angle between ground surface 428 and surfaces 422 and 426, and an angle between ground surface 448 and surfaces 442 and 446, as well as for surfaces of negative elevation portion 454. Sensors 202 may further be configured to ascertain an angle between top surface 404 and surfaces 402 and 406, peak point 424 and surfaces 422 and 426, and peak point 444 and surfaces 442 and 446.

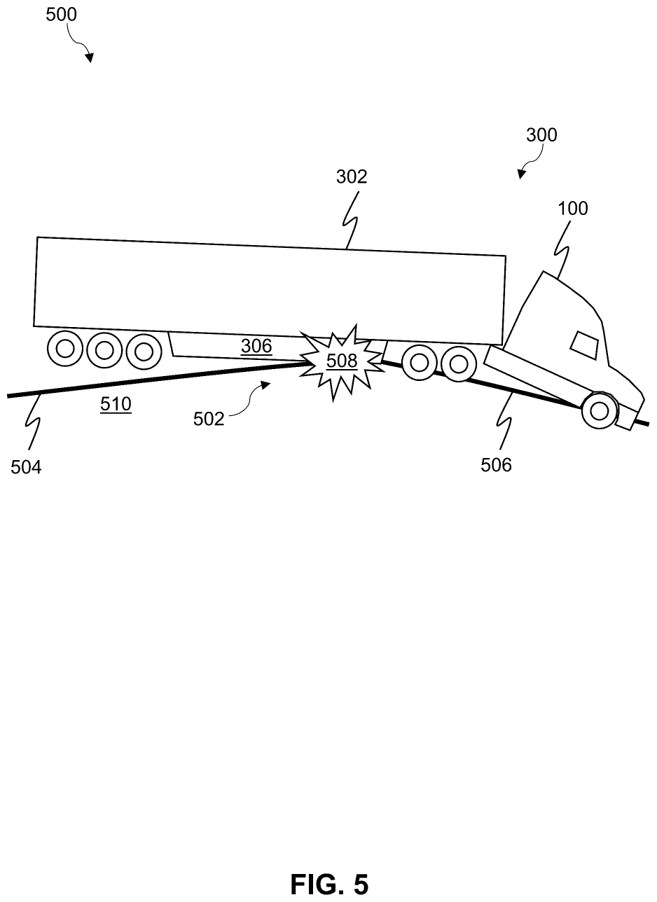

FIG. 5 is an example illustration of semi-trailer truck 300 shown in FIG. 3 in a hang up scenario 500. FIG. 5 illustrates an elevated road crossing 502 including a first curved surface 504 and second curved surface 506. As shown in FIG. 3, upon driving across elevated road crossing 502, a point of impact 508 has occurred between undercarriage 306 of semi-trailer truck 300 and a raised portion of elevated road crossing 502 such that semi-trailer truck 300 has become “hung up.” Moreover, in the scenario of FIG. 5, semi-trailer truck 300 is in a partial “high centered” scenario where certain wheels of semi-trailer truck 300 are not in contact with ground 510. Scenario 500 is an example situation which the systems and methods described herein are configured to prevent from happening and/or avoid all together.

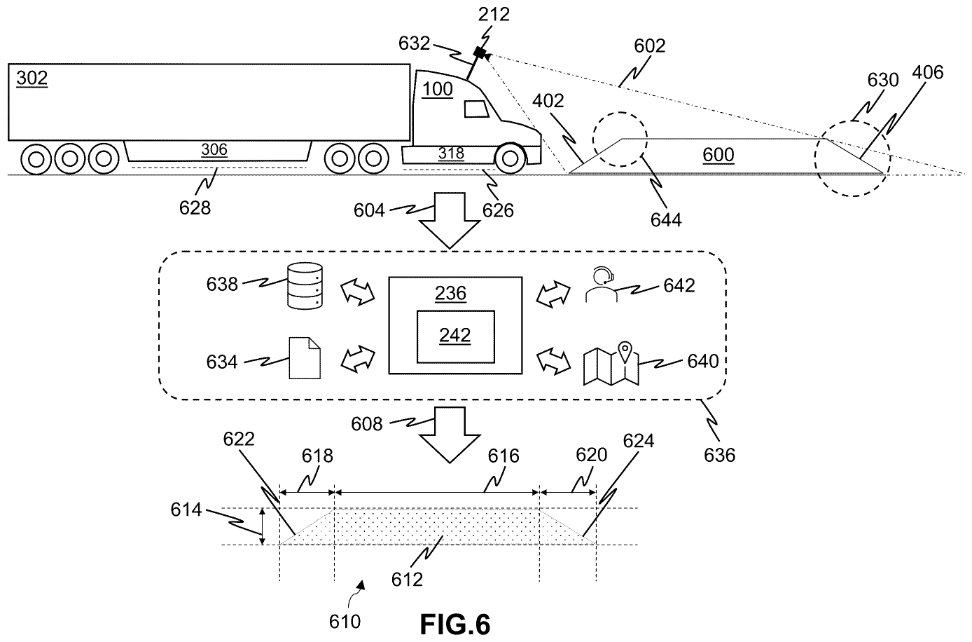

FIG. 6 is an example illustration of profiling of an elevated road surface feature 600, which may have a form factor and properties the same as or similar to the form factor and properties of elevated road surface feature 400 shown in FIG. 4A. As semi-trailer truck 300 approaches elevated road surface feature 600, LiDAR sensors 212 of autonomous vehicle 100, may, as part of their normal operation, emit laser pulses to generate a detailed point cloud of the terrain, including elevation data, which can be used for various applications as described herein. LiDAR sensors 212 may have an associated FOV 602. FOV 602 as shown in FIG. 6 is for example purposes only and is not limiting. For example, FOV 602 may range from ~20° to 360° , horizontal or vertical, depending on the type of LiDAR sensors used (e.g., spinning LiDAR sensors, front-facing FOV LiDAR sensors, narrow FOV LiDAR sensors, etc.). As autonomous vehicle 100 approaches elevated road surface feature 600, data 604 obtained via FOV 602 of LiDAR sensors 212 is used to generate a point cloud of an area in front of autonomous vehicle 100 including elevated road surface feature 600. Data 604 may be transmitted to and analyzed by various modules of autonomy computing system 200, such as perception and understanding module 236 and/or detection and reporting module 242. Output data 608 from perception and understanding module 236 and/or detection and reporting module 242 may include a profile 610 of elevated road surface feature 600 based upon a point cloud 612 that corresponds to and is representative of the geometrical properties of elevated road surface feature 600.

Profile 610 may include parameters of elevated road surface feature 600 derived from point cloud 612. Point cloud 612 may be derived at least in part from data 604. Parameters of profile 610 may correspond to geometrical properties of elevated road surface feature 600 derived from data 604, such as shown in and described in connection with FIG. 4A. Point cloud 612 may be a portion of an overall point cloud (not shown) of the area in front of autonomous vehicle 100, corresponding to data 604 obtained by LiDAR sensors 212. Profile 610 may include a height parameter 614 for elevated road surface feature 600. Profile 610 may include one or more length/width parameters for various portions of elevated road surface feature 600, including (i) a length/width 616 of a middle (e.g., flat) portion of elevated road surface feature 600, such as top surface 404 shown in in FIG. 4A, (ii) length/width 618 of a first angled portion of elevated road surface feature 600, such as first angled surface 402 shown in FIG. 4A, and (iii) a length/width 620 of a second angled portion of elevated road surface feature 600, such as second angled surface 406 shown in FIG. 4A. A total length/width of elevated road surface feature 600 may be determined by summing each of lengths/widths 616, 618, and 620. Profile 610 may further include (i) angle parameters 622 for a first angled portion of elevated road surface feature 600, such as first angled surface 402 shown in FIG. 4A and (ii) angle parameters 624 for a second angled portion of elevated road surface feature 600 such as second angled surface 406 shown in FIG. 4A. Results of a comparison of these parameters of profile 610 to corresponding parameters of the vehicle data are used as part of the determination as to whether autonomous vehicle 100 is permitted to drive across elevated surface feature 600, as described herein.

In one embodiment, a central line 626 associated with an undercarriage of autonomous vehicle 100 may be utilized as a reference point for making calculations, for example as autonomous vehicle 100 drives across elevated road surface feature 600. For example, central line 626 may split the distance between a height of an undercarriage and a surface upon which autonomous vehicle 100 is driving over, which may be a surface of first angled portion such as first angled surface 402 as autonomous vehicle 100 drives up first angled surface 402. Other sensors 202 may be implemented to assist with calculations relating to central line 626. For example, an IR transceiver (not shown) or an ultrasonic transceiver (not shown) may be located as part of undercarriage 318 of autonomous vehicle 100. Such an IR or ultrasonic transceiver may generally be configured in a downward facing orientation (e.g., pointing to the ground) and may emit pulses to the ground that, when reflections of such pulses are received back, determine a distance between central line 626 and the surface upon which autonomous vehicle 100 is driving over. Moreover, central line 626 may correlate to a central line 628 associated with undercarriage 306 of trailer 302 such that data corresponding to the clearance of undercarriage 318 when crossing first angled surface 402 may be correlated to undercarriage 306 which will subsequently cross over first angled surface 402. The same or similar central line-based process may be utilized in connection with semi-trailer truck 300 driving down a second angled surface such as that of second angled surface 406.

In some circumstances, fully or partially blocked portions 630 of elevated road surface feature 600 may not be able to be fully ascertained by LiDAR sensors 212, which may be reflected in point cloud 612 as missing data such that the resultant point cloud form factor does not fully map the real-world form factor of the real-world object such as elevated road surface feature 600. For example, LiDAR sensors 212 may include an expected range limit. If an object that is within the expected range limit is unable to be ascertained and profiled, that is an indication that the object may be blocked from view of LiDAR sensors. In such cases, mathematical extrapolations and/or other techniques may be implemented to “fill in the blanks” for any portion of elevated road surface feature 600 that data is unable to be obtained by LiDAR sensors 212. For example, autonomy computing system 200 may approximate a blocked portion 630 based on known data of another portion that has a substantially similar form factor as the blocked portion. With reference to FIGS. 4A and 6, if second angled surface 406 is unable to be ascertained by LiDAR sensors 212, autonomy computing system 200 may approximate the properties of second angled surface 406 with those of first angled surface 402. However, such approximation techniques generally may not have a degree of confidence as high as other techniques. These other techniques may include autonomous vehicle 100 including a movable element 632 to which sensors such as LiDAR sensors 212 may be attached. Movable element 632 may be an extendable rod, arm, or the like that is configured to be controlled by autonomy computing system 200 to protrude outwardly from a body of autonomous vehicle 100. Once extended, moveable element 632 may provide sensors such as LiDAR sensors 212 with a different viewpoint for purposes of being able to ascertain previously unascertainable objects such as second angled surface 406.

In general, autonomy computing system 200 may receive point cloud data associated with a point cloud obtained by operation of LiDAR sensors 212 and evaluates the point cloud data to determine if the point cloud data indicates a range that is within an acceptable threshold of an expected range limit of LiDAR sensors 212. This range limit may be device specific based on the make/model/type of LiDAR sensor. Based upon the evaluation of the point cloud data and a determination that the range is not within the acceptable threshold of the expected range limit, autonomy computing system 200 may change one or more operating behaviors of LiDAR sensors 212 and/or one or more operating behaviors of autonomous vehicle 100 to obtain new point cloud data. After any such changes, autonomy computing system 200 may then evaluate new point cloud data to determine whether a new range associated with the new point cloud data is within the acceptable threshold of the expected range limit. For example, in the context of the scenario shown in FIG. 6, if movable element 632 is not in an extended position, and LiDAR sensors 212 are unable to ascertain blocked portion 630, this may be construed as a range limit issue which causes autonomy computing system 200 to extend movable element 632 to a new height to change FOV 602 of LiDAR sensors 212. The adjustment of movable element 632 is a change in behavior of autonomous vehicle 100 to obtain new data. Once new data is obtained from LiDAR sensors 212 in the new position, it can be determined whether the new position of movable element 632 produces an acceptable threshold that complies with the expected range limit. For example, if blocked portion 630 can be ascertained based on the new position of LiDAR sensors 212, then an acceptable threshold may be determined to have been satisfied. Movement of movable element 632 and/or changing the operation of LiDAR sensors 202 may therefore permit a target area within the overall area of the driving environment to be focused upon even if the target area was previously unable to ascertained.

Additionally, operational parameters of LiDAR sensors 212 may be changed as part of changing behaviors of autonomous vehicle 100. For example, LiDAR sensors 212 may include settings capable of changing FOV 602 to be wider horizontally and/or vertically. Other internal or external data may also be used to assist in determining profile 610. For example, autonomy computing system 200 may be configured to reference other known data sources such as data from RADAR sensors 210, cameras 214, acoustic sensors 216, temperature sensors 218, and/or external image data such as map data. External image data may include map data that may include an aerial satellite view of elevated road surface feature 600, which may enable the entire shape and properties of a blocked portion to be ascertained from the aerial image data alone, and/or in combination with other known and/or obtained data. External image data may also include, for example, data from drones and/or other aerial devices that may be configured to obtain aerial images of elevated road surface feature 600. For example, a drone image may have a greater level of detail than a satellite image, and may be of greater assistance in ascertaining properties of the desired object or portion of the desired object.

In addition to detection and profiling as described herein, detection and reporting module 242 may also be configured to generate and transmit a report 634 including data and/or other information corresponding to the detected elevated road surface feature 600 via network 636 to one or more associated databases 638. In some embodiments, database 638 may be configured as an internal memory of autonomy computing system 200. In other embodiments, databases 638 may additionally, or alternatively, be remote (e.g., cloud) databases. Report 634 may include parameters of elevated road surface feature 600 as determined in connection with profile 610, including any associated data such as corresponding image data and the like. Report 634 may be formatted in a designated format for compliance with a format of a given database 638. For example, report 634 may include look-up tables and/or other formatted information so that it indexable and searchable via queries. Report 634 may include time and date when the data was obtained, etc., as well as map data 640. Map data 640 may include HD map data as described herein. Databases 638 may include an internal database in operative communication with autonomy computing system 200. Databases 638 may also include external databases such as a railroad crossing registry database or other elevated crossing database, which may be managed by a local municipal authority such as a transportation and/or roads and highways authority. Databases 638 may be accessible during a live driving session. Databases 638 may be implemented to store and report missing signs near railroad crossings and/or situations where it has been determined that data obtained and analyzed by autonomy computing system 200 and its various sensors and modules has significant variance with pre-recorded data for the same elevated road surface feature. For example, newly-obtained data of a certain railroad crossing may indicate that a height profile parameter is 50% different that a height parameter stored in a database 638 for the same elevated road surface feature, and may trigger sending of an electronic message or other alert to make such discrepancy known. Database 638 may then be updated if it is determined that the existing data is no longer accurate.

In some embodiments, map data 640 may be used in association with sensor data from sensors 202 to assist with making risk determinations and/or reporting elevated road surface features. Map data 640 may include external map data such as GPS data, drone data, as well as image/video and/or other data from RADAR sensors 210, LiDAR sensors 212, and cameras 214 of autonomous vehicle 100. An HD map associated with map data 640 may be a detailed representation of physical and semantic features in the driving environment. For example, this may include curbs, lane lines, stop signs, traffic signals, road geometries, road signs and poles, etc. New or updated map data 640 may be generated at the time of profiling an elevated road surface feature and included as part of report 634.

In some embodiments, a remote assistant 642 may be accessible via network 636. For example, remote assistant 642 may be a human assistant and/or a computer-based assistant that may be utilized to provide additional assistance in making determinations as to the level of risk associated with autonomous vehicle 100 crossing an elevated road surface feature. Remote assistant 642 may be granted authority to provide a final “yes” or “no” with respect to the determination of whether to cross an elevated road surface feature. Remote assistant 642 may be able to patch into sensor systems of autonomy computing system 200, such as cameras 214, to obtain a different view of a given object in the driving environment of autonomous vehicle 100. These are but some examples of how remote assistant 642 may be implemented to assist with the various determinations and situations described herein. For example, based on analysis results, it may be determined that additional data is desired for a target area 644. Remote assistant 642 may help ascertain properties of target areas such as target area 644. Additionally, or alternatively, target area 644 may be ascertained by changing a behavior of sensors 202, such as by adjusting LiDAR sensors 212 via movable element 632 and/or making other operational changes to sensors 202.

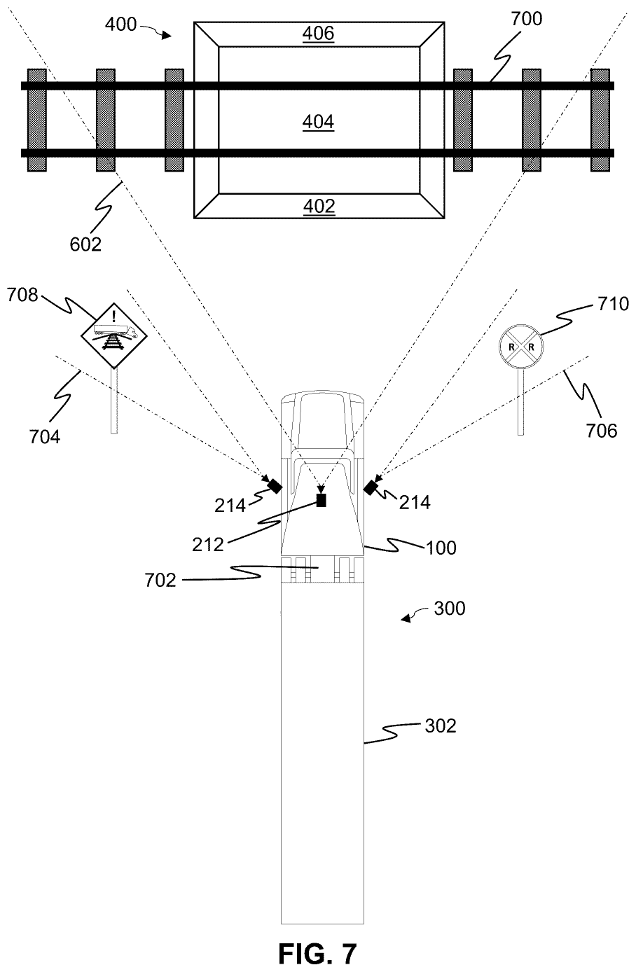

FIG. 7 is an example illustration of profiling of an elevated road surface feature such as a railroad crossing. With reference to FIG. 4A, FIG. 7 shows an elevated road surface feature of the type 400 shown in FIG. 4A, but that is embodied in FIG. 7 as a railroad crossing with railroad tracks 700 running therethrough. Elevated road surface feature 400 includes first angled surface 402, top surface 404, and second angled surface 406 as shown in and described in connection with FIG. 4A. Also, FIG. 7 illustrates additional aspects of semi-trailer truck 300 shown in FIG. 3, including hitch 702 and additional sensors of autonomous vehicle 100 that may include a pair of cameras 214 on each side of autonomous vehicle 100 as shown in FIG. 7. One camera 214 may have FOV 704 and the other camera 214 may have FOV 706. Cameras 214 and their respective FOVs 704 and 706 may be configured to capture images/videos of objects in the driving environment such as signs. Sign 708 within FOV 704 may be a sign warning of the risk of a “hang up” situation at this particular railroad crossing. Sign 710 within FOV 706 may be a railroad crossing sign warning that active trains pass on railroads tracks 700. Data corresponding to the presence of absence of signs such as signs 708 and 710 may be transmitted to one or more of databases 638.

Referring back to FIG. 6, LiDAR sensors 212 may have FOV 602 that, in the scenario shown in FIG. 7, is configured to encompass the entire railroad crossing. A result of the scanning of elevated road surface feature 400 via LiDAR sensor 212 as encompassed by FOV 602 may be generation of a profile 610 shown in and described in connection with FIG. 6. For example, profile 610 may include a height parameter 614 of top surface 404, a length/width 616 of a top surface 404, a length/width 618 of first angled surface 402 such as shown in FIGS. 4A and 6, a length/width 620 of second angled surface 406 such as shown in FIGS. 4A and 6, angle parameters 622 of first angled surface 402 such as shown in FIGS. 4A and 6, and angle parameters 624 of second angled surface 406 such as shown in FIGS. 4A and 6. Additionally, properties of hitch 702, such as the location and clearance of hitch 702, may be included as part of the vehicle data and utilized in connection with determining if it is safe for semi-trailer truck 300 to drive across elevated road surface feature 400, especially in a heightened danger zone in connection with railroad tracks 700.

Sign 708 may serve a warning function that due to close clearance to the road, trucks and trailers are prohibited from using a particular crossing. Put another way, when sign 708 is present, a driver of the vehicle (human or autonomous) should find another way across the railroad tracks. When making a determination as to whether to permit autonomous vehicle 100 to cross a railroad crossing, detection and reporting module 242 may assign significant weight to the detection of sign 708. For example, even if a comparison of the obtained measurements of the railroad crossing to the vehicle data indicates that it would be safe for autonomous vehicle 100 to cross the railroad crossing, the presence of sign 708 may be a determinative factor in the ultimate decision to not permit autonomous vehicle 100 be operated to drive across the railroad crossing. This is an example of using external, contextual data to supplement or override a determination based may have otherwise been based solely on profiling of the elevated road surface feature.

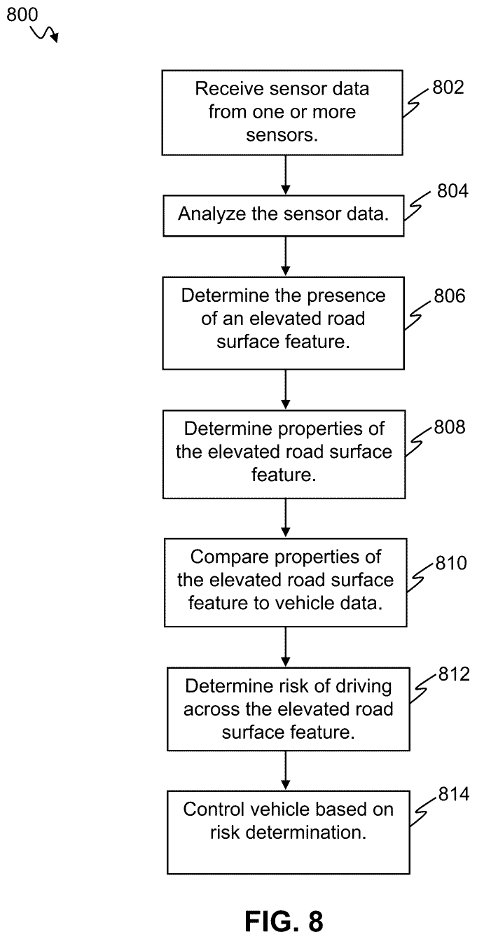

FIG. 8 is a flow-chart of method operations performed by an autonomy computing system 200 and/or its modules (e.g., detection and reporting module 242), shown in FIG. 2.

Method 800 may include receiving 802 sensor data from one or more of sensors 202, such as LiDAR sensors 212. As described herein, this data may be obtained during a live driving session when autonomous vehicle 100 encounters an elevated road surface feature such as the type(s) shown in and described in connection with FIGS. 4A-4C, for example.

Method 800 may also include analyzing 804 the sensor data. This may include detection and reporting module 242 analyzing the obtained sensor data from LiDAR sensors 212 to extract height, length, width, angle, etc. parameters for a given detected object such as an elevated road surface feature, as described herein, such as the types shown in and described in connection with FIGS. 4A-4C and 6. For example, data of point cloud 612 may be analyzed.

Method 800 further may include determining 806 the presence of an elevated road surface feature. Determining 806 may include piecing together data analyzed as part of analyzing 804 to build a profile such as profile 610 shown in FIG. 6, and determining that the profile matches that of an elevated road surface feature.

Method 800 yet further may include determining 808 properties of the elevated road surface feature. Determining 808 may include mapping the parameters from analyzing 804 to a profile (e.g., profile 610) resulting from determining 806 to assign height, length, width, angle, etc. properties to the corresponding portions of profile 610. Accordingly, geographical measurements and properties that approximate the real-world measurements of the elevated road surface feature to a high degree of accuracy may be generated.

Method 800 yet further may include comparing 810 properties of the elevated road surface feature to vehicle data and/or other external data. From analyzing 804, determining 806, determining 808, and comparing 810, the type of elevated road surface feature and all relevant parameters may be known, and may be able to be compared to known values in the vehicle data. For example, comparing 810 may include comparing a clearance threshold including clearance 308 and/or clearance 314 of semi-trailer truck 300 to profile 610 resulting from determining 808. Clearances such as 308 and 314 from the vehicle data may be compared with height parameter 614 of profile 610 to determine a level of risk associated with operating autonomous vehicle 100 to drive across an elevated road surface feature, including the risk of “hang up” based on if clearances 308/314 are greater than height parameter 614, and to what extent.

Comparing 810 may be based at least in part upon rules and/or algorithms that are stored within a memory of autonomy computing system 200 (or its one or more modules). The rules and/or algorithms may define how detection and reporting module 242 interprets the sensor data for purposes of making a determination of the level of risk. The level of risk may further be based upon a plurality of factors including contextual factors as described herein. For example, a height of the elevated road surface feature may be different due to a recent snow/ice storm and the accumulation of snow/ice on one or more surfaces of the elevated road surface feature. Detection and reporting module 242 may determine that the height of the elevated road surface feature is more than an expected height of the elevated road surface feature, and change the level of risk determination accordingly.

Detection and reporting module 242 may store in memory a last, or historical, profile of an elevated road surface feature as determined based on prior sensor data and update the profile with the new profile data. In addition to height, width, angle (e.g., slope) measurements, detection and reporting module 242 may also use distance measurements as a means of making determinations, such as distance from an elevated road surface feature to another nearby object such as a traffic light, a barrier or gate associated with a railroad crossing, a road sign, etc., as part of the detection and profiling processes in determining 806.

An output from comparing 810 may include a confidence score that provides a level of certainty corresponding to if autonomous vehicle 100 will sufficiently clear the elevated road surface feature. If the confidence score is at or above a certain threshold, autonomous vehicle 100 may be permitted to be operated to drive across the elevated road surface feature. If the confidence score is below the threshold, autonomous vehicle 100 may be precluded from being operated to drive across the elevated road surface feature. Additionally, in situations where there are additional levels of uncertainty, or where the confidence score is a borderline score on the cusp of being a “passing” “failing” score with respect to crossing/not crossing, a remote assistant such as remote assistant 642 may be utilized to help make a determination. For example, a confidence score of 75/100 may be coded within autonomy computing system 200 as being an acceptable threshold to allow autonomous vehicle 100 to proceed with crossing an elevated road surface feature, whereas a score below 75/100 would preclude the autonomous vehicle from being be permitted to cross.

Method 800 yet further may include determining 812 a level of risk of operating autonomous vehicle 100 to drive across an elevated road surface feature. Determining 812 may include evaluating the one or more confidence scores generated from comparing 810. The confidence scores may include a plurality of individual scores and/or a composite score that takes into account the individual scores. For example, a confidence score for height clearance may be an 89/100, whereas a confidence score for angle clearance may be 76/100. Each individual confidence score may be weighted to generate a composite confidence score. Each of receiving 802, analyzing 804, determining 806, determining 808, comparing 810, determining 812, and controlling 814 may be done in real-time during a live driving session of autonomous vehicle 100.

In one example scenario, after a significant snow storm, autonomous vehicle 100 may encounter a snow-covered railroad crossing. In this scenario, a result of comparing 810 may return a confidence score of exactly 75, which in normal situations would permit the autonomous vehicle to be driven across the railroad crossing. However, due to the contextual aspects relating to the weather conditions and the snow on the ground, a call may be made to remote assistant 642. Remote assistant 642 may determine that even though the resultant confidence score was a “passing” score of 75/100, the snow on the ground adds a level of unpredictability, and that it is safest to not cross the railroad crossing, despite the “passing” score of 75/100. As described herein, remote assistant 642 may be a human or computer-based, and as such the discretionary decisions from remote assistant 642 may be made by a human or by a computer. As such, determining the level of risk may be based solely on one or more confidence scores, or may be based on a more holistic perspective that considers both scores and/or other contextual factors to arrive a level of risk determination. The level of risk may be associated with a level of risk threshold similar to the confidence scores. For example, the level of risk threshold may use an X/10 scale, where anything 7/10 or higher is high risk and the autonomous vehicle should not be permitted to drive across and elevated road surface feature. This scale may be adjusted depending on the type of elevated road surface feature. For example, a level of risk scale for a railroad crossing may have a higher sensitivity such that anything 5/10 or higher precludes the autonomous vehicle from being driven over the railroad crossing (e.g., compared to 7/10 for crossings other than railroad crossings). The scoring/threshold scales for the confidence scores and risk levels described herein are merely examples and other scoring/scale systems may be implemented.

Method 800 yet further may include controlling 814 autonomous vehicle 100 based on the risk determination made in determining 812. A risk threshold may take into account not only individual or composite confidence scores for any given parameter comparison, but also contextual factors as described herein. That being said, if a critical (e.g., heavily weighted) individual confidence score such as for height clearance is below a defined confidence score, the risk threshold may be set to a level corresponding to not permitting autonomous vehicle 100 to be operated to drive across the elevated road surface feature, regardless of the weight of any other factors. The risk threshold may generally be a composite score taking into account a plurality of factors and outputting a simple “yes” or “no” determination based on the weighting of the various factors. As described herein, other contextual data may be utilized in combination with confidence scores to arrive at the ultimate risk level/risk threshold determination. External/contextual data may also be weighted and used as part of rules and/or algorithms to generate a risk level and/or final risk determination.

Real-world log data from test drives/test runs of autonomous vehicle 100 may be used to (i) determine rules that define how distances, heights, widths, angles, and other aspects of an elevated road surface feature are determined with respect to profiling elevated road surface features, and (ii) define rules for how profiling and an associated risk of crossing are determined. The real-world log data may include video logs, and other sensor logs. The rules may be used to define the algorithms that are used to navigate autonomous vehicle 100 in scenarios where elevated road surface features such as hump crossings and/or railroad crossings are present. For example, cameras of an autonomous vehicle may record the vehicle driving over railroad tracks where one or more railroad crossings are present. The video data may be used to set rules that define how the profiles of the railroad crossings will be defined and the risks associated with the railroad crossings, which may be different for each railroad crossing. Video data may also be used and implemented to define various distance, height, width, angle, and slope rules for determining geometry of elevated road surface features and/or other geometric relationships between other objects and/or characteristics of the road, railroad tracks, etc. For example, measurements may be taken from obtained videos regarding surface conditions of the material (e.g., concrete, asphalt, wood, etc.) of the nearby road, whether any gates/barriers and or warning lights or signs near the crossings are present and/or functioning properly, etc.

The rules may further be set based on a plurality of real-world scenarios, such as a scenario where an autonomous vehicle drives across an elevated road surface feature that is present on a drive path of the autonomous vehicle. By analyzing images, videos, and/or point clouds of such a scenario, rules may be set to control how the autonomous vehicle responds to an elevated road surface feature. This may include bifurcating types of elevated road surfaces features, such as railroad crossings and non-railroad crossings. These rules can then be used to define the algorithms that are used to detect and profile different types of elevated road surface features. Additionally, simulated driving data may be used and implemented to define such rules.

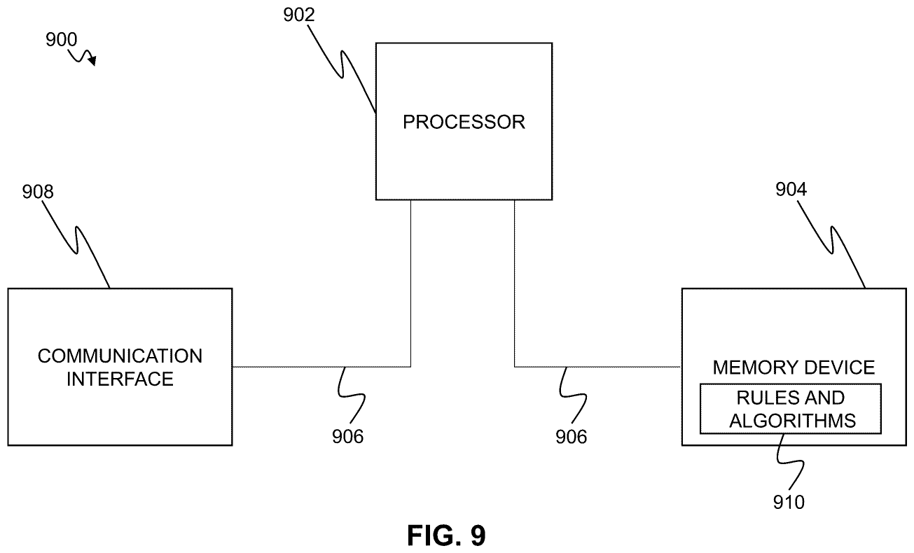

FIG. 9 is a block diagram of an example computing device 900. Autonomy computing system 200 may be implemented with one or more computing device(s) 900. Computing device 900 includes a processor 902 and a memory device 904. The processor 902 is coupled to the memory device 904 via a system bus 906. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 904 includes one or more devices that enable information, such as executable instructions or other data (e.g., sensor data), to be stored and retrieved. Moreover, the memory device 904 includes one or more computer readable media, such as, without limitation, dynamic random access memory (DRAM), static random access memory (SRAM), a solid state disk, or a hard disk. In the example embodiment, the memory device 904 stores, without limitation, application source code, application object code, configuration data, additional input events, application states, assertion statements, validation results, or any other type of data. The computing device 900, in the example embodiment, may also include a communication interface 908 that is coupled to the processor 902 via system bus 906. Moreover, the communication interface 908 is communicatively coupled to data acquisition devices.

In the example embodiment, processor 902 may be programmed by encoding an operation using one or more executable instructions and providing the executable instructions in the memory device 904. In the example embodiment, the processor 902 is programmed to select a plurality of measurements that are received from data acquisition devices. In the example embodiment, rules and algorithms 910 are stored in memory device 904. Rules and algorithms 910 may include any/all of the rules and/or algorithms described herein.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some of the problems addressed herein include: inability of existing systems to (a) accurately determine the presence and/or properties of elevated road surface features, (b) accurately determine whether it is safe for an autonomous vehicle to drive across a given elevated road surface feature; (c) perform tasks relating to detecting and profiling objects encountered by an autonomous vehicle in real-time during a live driving session and controlling the autonomous vehicle based on real-time determinations made as to the objects encountered by the autonomous vehicle; and/or (d) accurately report the presence and profile of objects such as elevated road surface features to databases and/or other services that concern elevated road surface features such as railroad crossings, etc.

An example technical effect of the methods, systems, and apparatus described herein includes at least one of: (a) accurate determination and profiling of an elevated road surface feature based on measurements and determinations made from sensor data; (b) use of contextual data such as map data, highway data, sign data, accident data, and/or other external data to accurately determine a level of risk associated with permitting an autonomous vehicle to drive across an elevated road surface feature; (c) updating a travel path of an autonomous vehicle in accordance with a determination made as to whether to permit an autonomous vehicle to cross an elevated road surface feature; and (d) improving safety and security of an autonomous vehicle while driving in an environment with elevated road surface features.

Additionally, or alternatively, the systems and methods described herein may be embodied in a standalone sensor device that may be configured to perform the systems and methods described herein and that may be implemented into any vehicle type, including both autonomous and non-autonomous vehicles. For example, an after-market sensor device may be installable and/or integrated into an autonomous vehicle to provide additional sensing capabilities to the autonomous vehicle, where outputs from the standalone sensor device may be able to be processed by autonomy computing system 200 to further assist in operation of the autonomous vehicle. In the case of a non-autonomous such as a non-autonomous tractor trailer, a standalone sensor device may include its own display or other alert mechanism (e.g., visual indicators (e.g., LEDs), audible sounds (e.g.,. beeps), etc.) to convey whether or not it is safe for the vehicle to cross a given elevated road surface feature. Such as standalone sensor device may be installable as a retro-fit, after-market solution into a non-autonomous vehicle. Moreover, a standalone sensor device may include built-in wireless communications or be able to utilize a data connection provided by a driver's mobile communication device (e.g., mobile phone or mobile hot spot) to have access to a network such as network 636 so that data obtained by the standalone sensor device may be analyzed via associated network computing systems in connection with determining a level of risk in crossing a given elevated road surface feature, for example.

Additionally, or alternatively, the systems and methods described herein may be applied to other driving situations where “hang up” issues may occur, including but not limited to short vertical curves, roadway crowns, sharp grade breaks such as those commonly found at bridge approaches and/or driveway access points, and/or more nuanced railroad-highway grade crossings.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. The instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle for detecting elevated road surface features, the autonomy computing system comprising at least one processor in communication with at least one memory device, the at least one processor programmed to:
receive driving environment data associated with a current driving environment of the autonomous vehicle based upon analysis of sensor data from one or more sensors of the autonomous vehicle;
analyze the driving environment data to (i) determine that one or more elevated road surface features are present within an area of the driving environment and (ii) determine a plurality of properties of the one or more elevated road surface features present within the area of the driving environment;
compare the plurality of properties of the one or more elevated road surface features to vehicle data of the autonomous vehicle to generate a plurality of comparison parameters;
based upon an analysis of the plurality of comparison parameters, determine a level of risk associated with whether to permit the autonomous vehicle to be operated to drive across the one or more elevated road surface features; and
control the autonomous vehicle to operate in accordance with the determined level of risk.

2. The autonomy computing system of claim 1, wherein the plurality of comparison parameters includes at least (i) a clearance threshold of the autonomous vehicle, and (ii) a profile of the one or more elevated road surface features, and wherein the at least one processor is further programmed to:
determine, based upon a comparison between data corresponding to the clearance threshold of the autonomous vehicle and data corresponding to the profile of the one or more elevated road surface features, whether the autonomous vehicle has sufficient clearance to avoid a hang up on the one or more elevated road surface features if the autonomous vehicle were to be operated to drive across the one or more elevated road surface features.

3. The autonomy computing system of claim 2, wherein the one or more sensors includes a camera configured to obtain camera data as part of the sensor data, and wherein the at least one processor is further programmed to:
analyze the camera data to determine whether a sign warning about the one or more elevated road surface features is present within the area of the driving environment; and
update the comparison based upon a determination made in connection with the analyzed camera data.

4. The autonomy computing system of claim 1, wherein the at least one processor is further programmed to:
perform an analysis of at least one of (i) map data associated with the current driving environment or (ii) historical accident data associated with the current driving environment;
update the level of risk based upon a result of the analysis of the at least one of the map data or the accident data; and
control the autonomous vehicle to operate based upon the updated level of risk.

5. The autonomy computing system of claim 1, wherein the at least one processor is further programmed to:
determine the presence or absence of one or more road signs within the area of the driving environment based on the sensor data; and
transmit sign data associated with the determined presence or absence of the one or more road signs to an electronic database configured to store information relating to known elevated road surface features.

6. The autonomy computing system of claim 1, wherein the at least one processor is further programmed to:
transmit the driving environment data to a remote assistance program and receive assistance from the remote assistance program in connection with one or more of (i) controlling the autonomous vehicle to drive across the one or more elevated road surface features, or (ii) the level of risk.

7. The autonomy computing system of claim 1, wherein the at least one processor is further programmed to:
operate the autonomous vehicle to (i) drive across the one or more elevated road surface features when the level of risk is determined to be at or below a risk threshold or (ii) not drive across the one or more elevated road surface features when the level of risk is determined to be above the risk threshold.

8. The autonomy computing system of claim 1, wherein the at least one processor is further programmed to:
change one or more driving behaviors of the autonomous vehicle when the level of risk is determined to be above the risk threshold; and
operate the autonomous vehicle based upon the one or more changed driving behaviors.

9. The autonomy computing system of claim 1, wherein a subset of the one or more sensors is mounted on a movable element of the autonomous vehicle, and wherein the at least one processor is further programmed to:
determine a target area within the area of the driving environment upon which the subset of the one or more sensors is to be focused; and
control the movable element to move to a position such that the subset of the one or more sensors is focused upon the target area.

10. The autonomy computing system of claim 1, wherein the one or more sensors includes one or more light detection and ranging (LiDAR) sensors, and the at least one processor is further programmed to:
receive point cloud data associated with a point cloud obtained by operation of the one or more LiDAR sensors; and
evaluate the point cloud data to determine if the point cloud data indicates a range that is within an acceptable threshold of an expected range limit of the one or more LiDAR sensors.

11. The autonomy computing system of claim 10, wherein the at least one processor is further programmed to:
based upon the evaluation of the point cloud data and a determination that the range is not within the acceptable threshold of the expected range limit, change at least one of (i) one or more operating behaviors of the one or more LiDAR sensors, or (ii) one or more operating behaviors of the autonomous vehicle to obtain new point cloud data; and
evaluate the new point cloud data to determine whether a range associated with the new point cloud data is within the acceptable threshold of the expected range limit.

12. One or more non-transitory computer-readable storage media for detecting elevated road surface features by an autonomous vehicle, the one or more non-transitory computer-readable storage media comprising a plurality of instructions stored thereon that, in response to being executed, cause the autonomous vehicle to:
receive driving environment data associated with a current driving environment of the autonomous vehicle based upon analysis of sensor data from one or more sensors of the autonomous vehicle;
analyze the driving environment data to (i) determine that one or more elevated road surface features are present within an area of the driving environment and (ii) determine a plurality of properties of the one or more elevated road surface features present within the area of the driving environment;
compare the plurality of properties of the one or more elevated road surface features to vehicle data of the autonomous vehicle to generate a plurality of comparison parameters;
based upon an analysis of the plurality of comparison parameters, determine a level of risk associated with whether to permit the autonomous vehicle to be operated to drive across the one or more elevated road surface features; and
control the autonomous vehicle to operate in accordance with the determined level of risk.

13. The one or more non-transitory computer-readable storage media of claim 12, wherein the plurality of comparison parameters includes at least (i) a clearance threshold of the autonomous vehicle, and (ii) a profile of the one or more elevated road surface features, and wherein the instructions, in response to being executed, further cause the autonomous vehicle to:
determine, based upon a comparison between data corresponding to the clearance threshold of the autonomous vehicle and data corresponding to the profile of the one or more elevated road surface features, whether the autonomous vehicle has sufficient clearance to avoid a hang up on the one or more elevated road surface features if the autonomous vehicle were to be operated to drive across the one or more elevated road surface features.

14. The one or more non-transitory computer-readable storage media of claim 12, wherein the instructions, in response to being executed, further cause the autonomous vehicle to:
perform an analysis of at least one of (i) map data associated with the current driving environment or (ii) historical accident data associated with the current driving environment;
update the level of risk based upon a result of the analysis of the at least one of the map data or the accident data; and
control the autonomous vehicle to operate based upon the updated level of risk.

15. The one or more non-transitory computer-readable storage media of claim 12, wherein the instructions, in response to being executed, further cause the autonomous vehicle to:
determine the presence or absence of one or more road signs within the area of the driving environment; and
transmit sign data associated with the determined presence or absence of the one or more road signs to an electronic database configured to store information relating to known elevated road surface features.

16. The one or more non-transitory computer-readable storage media of claim 12, wherein the instructions, in response to being executed, further cause the autonomous vehicle to:
transmit the driving environment data to a remote assistance program and receive assistance from the remote assistance program in connection with one or more of (i) controlling the autonomous vehicle to drive across the one or more elevated road surface features, or (ii) the level of risk.

17. The one or more non-transitory computer-readable storage media of claim 12, wherein the instructions, in response to being executed, further cause the autonomous vehicle to:
operate the autonomous vehicle to (i) drive across the one or more elevated road surface features when the level of risk is determined to be at or below a risk threshold or (ii) not drive across the one or more elevated road surface features when the level of risk is determined to be above the risk threshold.

18. The one or more non-transitory computer-readable storage media of claim 12, wherein the instructions, in response to being executed, further cause the autonomous vehicle to:
change one or more driving behaviors of the autonomous vehicle when the level of risk is determined to be above the risk threshold; and
operate the autonomous vehicle based upon the one or more changed driving behaviors.

19. The one or more non-transitory computer-readable storage media of claim 12, wherein a subset of the one or more sensors is mounted on a movable element of the autonomous vehicle, and wherein the instructions, in response to being executed, further cause the autonomous vehicle to:
determine a target area within the area of the driving environment upon which the subset of the one or more sensors is to be focused; and
control the movable element to move to a position such that the subset of the one or more sensors is focused upon the target area.

20. The one or more non-transitory computer-readable storage media of claim 12, wherein the one or more sensors includes one or more light detection and ranging (LiDAR) sensors, and wherein the instructions, in response to being executed, further cause the autonomous vehicle to:
receive point cloud data associated with a point cloud obtained by operation of the one or more LiDAR sensors; and
evaluate the point cloud data to determine if the point cloud data indicates a range that is within an acceptable threshold of an expected range limit of the one or more LiDAR sensors.
